(19) United States
(12) Patent Application Publication
(10) Pub. No.: US 2008/0157658 A1
(43) Pub. Date: Jul. 3, 2008

(54) ORGANIC ELECTROLUMINESCENT DISPLAY DEVICE

(76) Inventors: Yoshinori Ishii, Chiba (JP); Satoru Kase, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/960,825

(22) Filed: Dec. 20, 2007

(30) Foreign Application Priority Data
Dec. 20, 2006 (JP) 2006-342544

(51) Int. Cl. H01J 63/04

(52) U.S. Cl. 313/504

(57) ABSTRACT

An object of the present invention is to provide a bottom emission type organic EL display device that has a light-emitting element unit thereof protected from being damaged by a stored desiccant, that has a long service life, and that exhibits excellent display characteristics of a high luminance and a high contrast. The solution is such that the organic EL display device includes a desiccant assembly which is disposed on the internal side of a sealing substrate and which has a cushioning member thereof jutted out of the surface of a desiccant.

### CROSS-REFERENCE TO RELATED APPLICATIONS

The disclosure of Japanese Patent Application No. 2006-342544 filed on 2006/12/20 (yyyy/mm/dd) including the claims, the specification, the drawings and the abstract is incorporated herein by reference in its entirety.

### BACKGROUND OF THE INVENTION

1. Field of the Invention

The present invention relates to an organic electroluminescent (EL) display device, or more particularly, to an organic EL display device including bottom emission type organic EL display elements.

2. Description of the Related Art

As flat panel display devices, a liquid crystal display device (LCD), a plasma display device (PDP), a field emission display device (FED), and an organic electroluminescent (EL) display device (OLED) have been put to practical use or have been studied in order to pave the way for practical use. Above all, the organic EL display device is a quite promising display device as a prototype of a thin and lightweight emissive display device.

The organic EL display device falls into a so-called bottom emission type and a so-called top emission type. The bottom emission type organic EL display device has organic EL elements thereof realized with a luminous mechanism. The luminous mechanism has a transparent electrode (made of ITO or the like) which serves as a lower electrode or one electrode, a multilayer organic film (may be referred to as an organic light-emitting layer) which emits light responsively to application of an electric field, and a reflective metallic electrode, which serves as an upper electrode or the other electrode, sequentially accumulated on a major side of an element substrate that is preferably a glass substrate realizing a TFT substrate.

The numerous organic EL elements are arrayed in the form of a matrix. A sealing substrate or a sealing film referred to as a sealing can is included to cover the laminated structure. The perimeters of the element substrate and sealing substrate are sealed with a sealant in order to shield the luminous structure from an external atmosphere.

For example, the upper electrode that is the metallic electrode is used as an anode, and the lower electrode that is the transparent electrode is used as a cathode. When an electric field is applied to the inter-electrode space, carriers (electrons and holes) are injected into the organic multilayer film. This causes the organic multilayer film to emit light. The light is radiated to outside from the element substrate side of the display device.

This type of organic EL display device is structured to have a sealing substrate 71 and an element substrate 72 sealed with a sealant 73 in the same manner as an example shown in FIG. 10. FIG. 10 is an illustrative sectional view in a direction parallel to a light emitting direction of an example of an organic EL display device. In the structure shown in FIG. 10, a pit 81a is formed in the internal side of a sealing substrate 81 that faces an element substrate 82, and a desiccant assembly 84 is locked in the pit 81a. The desiccant assembly 84 includes a desiccant 86 made of, for example, calcium oxide (CaO) or strontium (Sr) and a bonding member 87, for example, an adhesive. The bonding member 87 causes the desiccant assembly to adhere to the sealing substrate 81.

On the other hand, a light-emitting element unit 85 is disposed on the major side of the element substrate 82, that is, the side of the element substrate 82 which is opposed to the sealing substrate 81 and on which TFT elements and the like that are not shown are formed. The light-emitting element unit 85 has a transparent lower electrode 88, an organic multilayer film 89 including a light-emitting layer, and an upper electrode 90, which is realized with a reflective metallic film, sequentially accumulated on the element substrate 82.

In the foregoing construction, the desiccant assembly 84 is included for hindering deterioration in performance derived from water absorption by the organic multilayer film 89. Therefore, the surface of the desiccant 86 should preferably have a large area and have irregularities.

Moreover, the pit 81a is used to increase the volume of the desiccant assembly 84 so as to improve the water absorbency. However, the thickness of the portion of the substrate having the pit tends to be smaller than that of the other portion.

Concerning the foregoing type of organic EL display device, a patent document 1 has disclosed the property of a desiccant and a technology for mounting the desiccant.

Incidentally, the patent document 1 refers to JP-A-2003-154227 (foreign equivalent publication: U.S. Pat. No. 6,740,145).

### SUMMARY OF THE INVENTION

For the foregoing organic EL display device, the work of externally pressurizing a substrate is performed at a step of bonding a sheet deflector to, for example, the external side of the substrate in the course of manufacturing. The substrate is deformed during the pressurization. Consequently, a desiccant and a light-emitting element unit come into contact with each other. This poses a problem in that the light-emitting element unit is damaged to degrade a display characteristic.

The problem may become serious in large-scale display devices.

An object of the present invention is to solve the foregoing problem and to provide an excellent organic EL display device that has a long service life and offers a high luminance and a high contrast.

In order to accomplish the above object, the present invention adopts a structure in which a desiccant assembly, which is disposed to face an upper electrode placed on an organic EL layer, has a cushioning member jutted out of the surface of a desiccant toward the upper electrode.

Since the present invention has the structure in which the cushioning member is disposed on the surface of the desiccant assembly facing the upper electrode, there is no fear that the desiccant assembly may damage the upper electrode. Consequently, there is provided an organic EL display device in which the volume of the desiccant assembly can be increased and the water absorbency thereof can be kept satisfactory over a long period of time, and which has a long service life and exhibits excellent display characteristics of a high luminance and a high contrast. Moreover, a pit in which the desiccant assembly is locked can be formed readily.

### BRIEF DESCRIPTION OF THE INVENTION

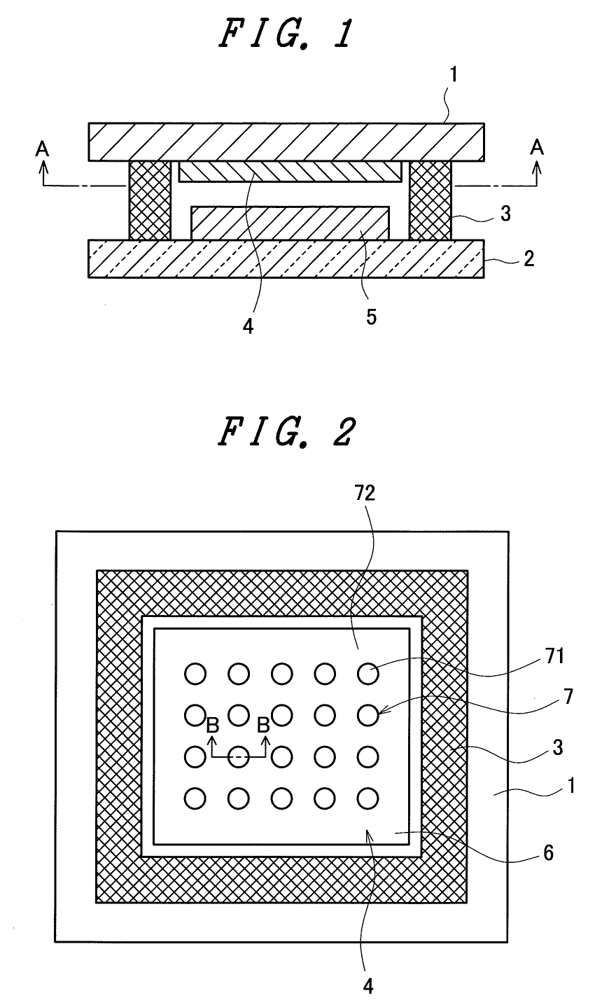

FIG. 1 is an illustrative sectional view for use in explaining the outline structure of an embodiment of an organic EL display device in accordance with the present invention;

FIG. 2 is an illustrative sectional view along an A-A line in FIG. 1;

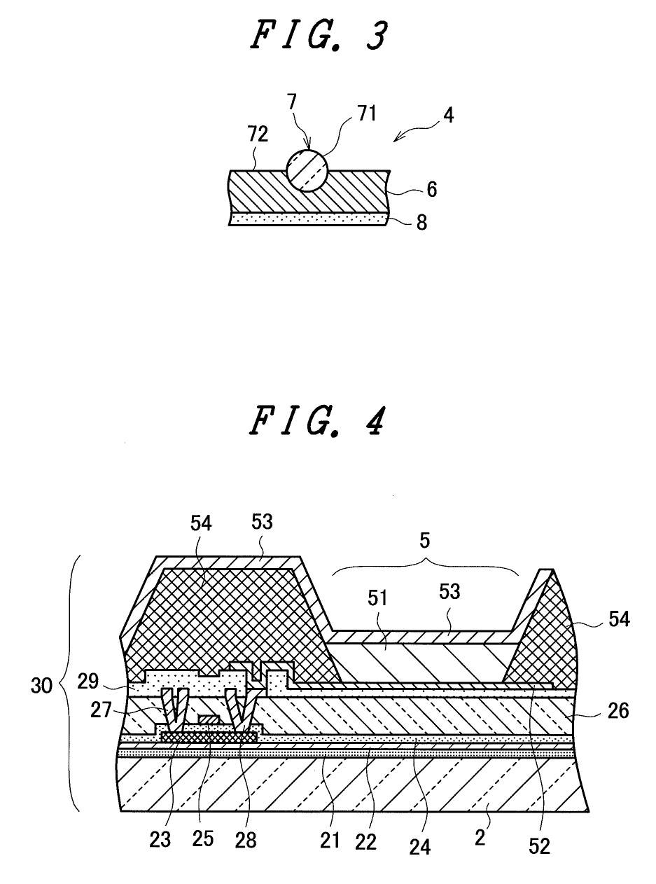

FIG. 3 is an illustrative sectional view along a B-B line in FIG. 2;

FIG. 4 is an illustrative sectional view of the light-emitting element side of the structure shown in FIG. 1;

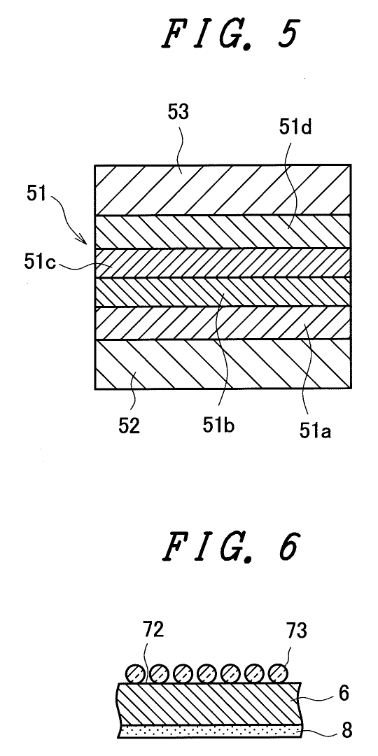

FIG. 5 is an illustrative sectional view of an organic EL layer included in the structure shown in FIG. 1;

FIG. 6 is an illustrative sectional view for use in explaining another embodiment of an organic EL display device in accordance with the present invention;

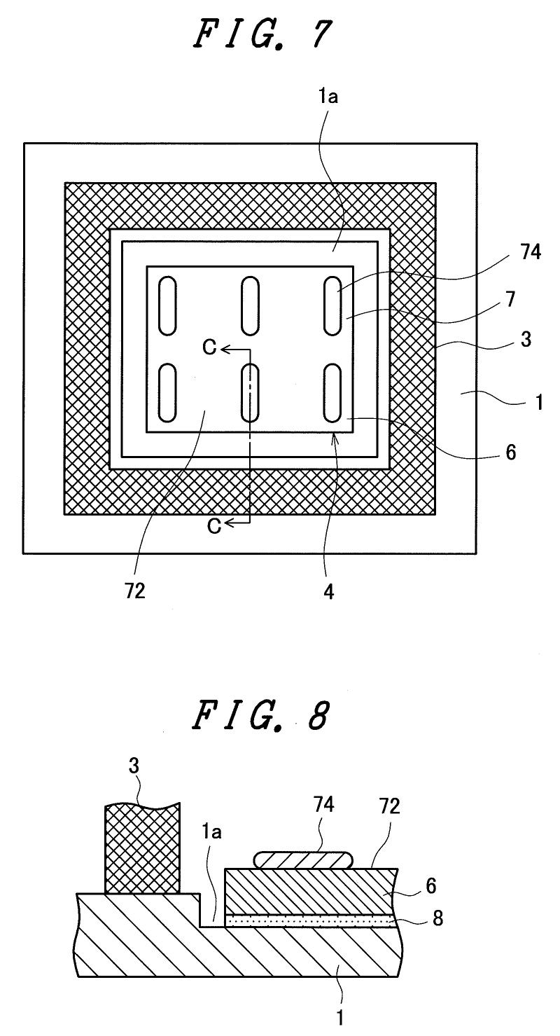

FIG. 7 is an illustrative plan view for use in explaining still another embodiment of an organic EL display device in accordance with the present invention;

FIG. 8 is an illustrative sectional view along a C-C line shown in FIG. 7;

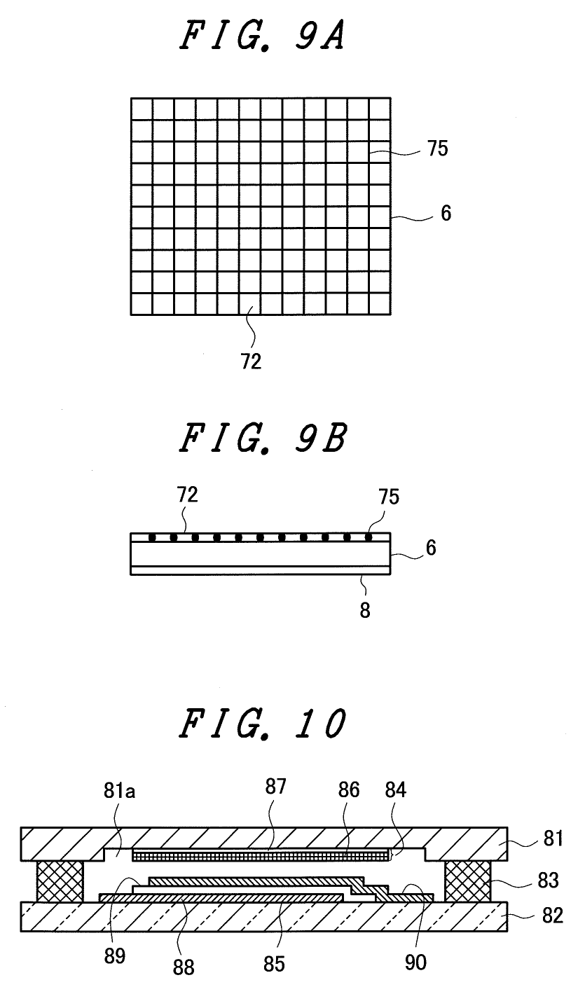

FIG. 9A and FIG. 9B are explanatory diagrams concerning still another embodiment of an organic EL display device in accordance with the present invention, FIG. 9A is an illustrative plan view, and FIG. 9B is an illustrative side view of a structure shown in FIG. 9A; and

FIG. 10 is an illustrative sectional view of a conventional organic EL display device.

### DETAILED DESCRIPTION OF THE INVENTION

Referring to the drawings, embodiments of the present invention will be described below.

### First Embodiment

FIG. 1 to FIG. 5 are illustrative views for use in explaining the outline structure of an embodiment of an organic electroluminescent (EL) display device in accordance with the present invention. FIG. 1 is a sectional view in a direction parallel to a light-emitting direction. FIG. 2 is a sectional view along an A-A line in FIG. 1. FIG. 3 is an enlarged sectional view along a B-B line in FIG. 2. FIG. 4 is a sectional view of the light-emitting element side of the structure shown in FIG. 1. FIG. 5 is an enlarged sectional view of an organic EL layer.

In FIG. 1 to FIG. 5, there are shown a sealing substrate 1 that is, for example, a glass member, an element substrate 2, and a sealant 3. The sealant 3 is used to join the sealing substrate 1 and element substrate 2. Also shown are a desiccant assembly 4, a light-emitting element unit 5, a desiccant 6, a cushioning member 7, and a bonding member 8.

The element substrate 2 is a substrate that is preferably realized with a transparent glass having a silicon nitride SiN film 21 and a silicon oxide SiO₂ film 22 formed on the major side thereof, and that serves as the aforesaid TFT substrate. First gates 23 are formed in switching element areas on the silicon oxide SiO₂ film by patterning a semiconductor film. A gate insulating film 24 is formed to cover the first gates 23. Second gates 25 are patterned on the gate insulating film 24, and an insulating flattening film 26 is formed to cover the second gates.

Wiring 27 is wiring (inter-switch wiring, signal wiring, and drain wiring) interconnecting switching elements and realizing the drain electrodes of the switching elements. Moreover, wiring 28 refers to wiring that realizes the source electrodes of the switching elements, interconnects the switching elements, and serves as shielding members (inter-switch wiring and shielding members), and is led to the first gates 23 through contact holes that penetrate through the flattening film 26 and gate insulating film 24. An insulating film 29 is formed to cover the inter-switch wiring 27 and the inter-switch wiring and shielding members 28. A lower electrode 52 that is shaped like a flat plate and connected to the inter-switch wiring and shielding members 28 through contact holes formed in the insulating film 29 is extending in a luminous area. Herein, the lower electrode 52 is a cathode. Reference numeral 30 denotes a thin-film transistor (TFT) substrate.

The desiccant assembly 4 includes the desiccant 6 made of the aforesaid material, the cushioning member 7 that adopts a spherical shape, a net-like shape, a rod-like shape, or a sheet-like shape and is made of a polymer, a Teflon (registered trademark)-coated fiber, zeolite, or the like, and the bonding member 8 realized with an adhesive. Pellets 71 included in the cushioning member 7 are jutted out of one surface of the desiccant 6, and the bonding member 8 is attached to the other surface of the desiccant 6. The bonding member 8 is used to fix the desiccant assembly to the sealing substrate 1. A clearance portion 72 other than the multiple scattered pellets 71 is a bared portion of the desiccant 6.

For the construction of the first embodiment, for example, the pellets 71 of the cushioning member 7 are sprayed to the surface of the desiccant 6 and a solvent is removed. The dimension of each of the pellets 71 should range, for example, about 50 μm to about 200 μm for manifestation of a cushioning effect.

The light-emitting element unit 5 is disposed on the major side of the element substrate 2 while being opposed to the desiccant assembly 4. The light-emitting element unit 5 has the lower electrode 52 disposed on the insulating film 29 on the element substrate 2. The lower electrode 52 is connected to the inter-switch wiring and shielding members 28 through the contact holes formed in the insulating film 29. Herein, as mentioned above, the lower electrode 52 is a cathode.

An organic EL layer 51, an upper electrode 53 exhibiting reflectivity, and a jetty-like bank 54 are placed on the lower electrode 52. A region surrounded by the bank 54 acts as the luminous area. The bank 54 is made of an inorganic insulating material such as silicon oxide film or silicon nitride film, and has an opening portion (bank opening) in the luminous area. In other words, the bank 54 has a dent in the opening portion. The organic EL layer 51 is disposed like a matrix in an x direction and a y direction alike.

FIG. 5 shows an example of the organic EL layer 51 in detail. The organic EL layer 51 shown in FIG. 5 has an electron transport layer 51a disposed in contact with the lower electrode 52. A light-emitting layer 51b, a hole transport layer 51c, and a hole injection layer 51d are sequentially accumulated on the electron transport layer 51a. The upper electrode 53 is formed as the uppermost layer.

The organic EL display device in accordance with the first embodiment has the pellets 71 scattered in order to protect the light-emitting element unit 5 from being damaged. Moreover, the clearance portion 72 is so wide that the performance of the desiccant 6 can be fully drawn out.

### Second Embodiment

FIG. 6 is an illustrative sectional view similar to FIG. 3 for use in explaining the outline structure of another embodiment of an organic EL display device in accordance with the present invention. The same reference numerals are assigned to the components identical to those shown in the drawings referred to previously.

In FIG. 6, the desiccant assembly 4 fixed to the sealing substrate by the bonding member 8 has numerous polymer beads 73 scattered on the surface of the desiccant 6 and secured with a binder. The size of each of the beads 73 should range, for example, from about 50 μm to about 200 μm for manifestation of a cushioning effect.

The organic EL display device in accordance with the second embodiment features that the beads 73 can be readily equidistantly arranged on the surface of the desiccant 6 and that the performance of the desiccant 6 can be fully drawn out.

### Third Embodiment

FIG. 7 and FIG. 8 are illustrative diagrams for use in explaining the outline structure of still another embodiment of an organic EL display device in accordance with the present invention. FIG. 7 is a plan view similar to FIG. 2. FIG. 8 is a sectional view along a C-C line in FIG. 7. The same reference numerals are assigned to the components identical to those shown in the drawings referred to previously.

In FIG. 7 and FIG. 8, a pit 1a is formed in the internal side of the sealing substrate 1, and the desiccant assembly 4 having a structure to be described later is locked in the pit 1a. The desiccant assembly 4 has the cushioning member 7 thereof realized with multiple rods 74. The rods 74 are fixed to the surface of the desiccant 6. The desiccant assembly 4 is locked in the pit 1a by means of the bonding member 8. The dimension of each of the rods 74 ranges, for example, from about 50 μm to about 200 μm in diameter as described above, and the length thereof is properly determined in relation to the dimension of the light-emitting element unit.

The organic EL display device in accordance with the third embodiment has the rods 74 scattered in order to protect the light-emitting element unit 5 from being damaged. Moreover, the clearance portion 72 is so wide that the performance of the desiccant 6 can be fully drawn out.

### Fourth Embodiment

FIG. 9A and FIG. 9B are illustrative diagrams for use in explaining the outline structure of still another embodiment of an organic EL display device in accordance with the present invention. FIG. 9A is a plan view, and FIG. 9B is a side view of the structure shown in FIG. 9A. The same reference numerals are assigned to components identical to those shown in the drawings referred to previously.

In FIG. 9A and FIG. 9B, the desiccant assembly 4 includes a net-like body 75 as the cushioning member 7. The thickness of the net-like body 75 should range, for example, from about 50 μm to 200 μm for manifestation of a cushioning effect. The net-like body 75 is placed on the surface of the desiccant 6. The desiccant assembly is fixed to the sealing substrate, which is not shown, by means of the bonding member 8 attached to the back of the desiccant 6.

The organic EL display device in accordance with the fourth embodiment adopts the net-like body 75 as the cushioning member 7. This makes it easy to construct the desiccant assembly. Further, the performance of the desiccant 6 can be fully drawn out owing to the openings in the intervals of the net.

In the aforesaid embodiments, the desiccant and cushioning member are displayed as different layers. As long as the cushioning member is jutted out of the desiccant toward the light-emitting element unit, the desiccant and cushioning member may coexist, though the shape of the desiccant has to be devised.

Moreover, although an active type is taken for instance, the present invention can also be applied to a passive type.

What is claimed is:

1. An organic electroluminescent (EL) display device comprising organic EL display elements that include a lower electrode disposed on the major side of an element substrate, an organic EL layer which has a multilayer structure and is disposed on the lower electrode, an upper electrode disposed on the organic EL layer, a desiccant assembly opposed to the upper electrode with a predetermined space between them, a sealing substrate which holds the desiccant assembly and is opposed to the element substrate, and a sealant which joins the sealing substrate and element substrate, and that radiate light from the lower electrode side thereof, wherein:
the desiccant assembly has a cushioning member jutted out of the surface of a desiccant toward the upper electrode.

2. The organic EL display device according to claim 1, wherein the cushioning member has substantially spherical pieces scattered on the surface of the desiccant.

3. The organic EL display device according to claim 1, wherein the cushioning member is a sheet-like member and has numerous openings through which the surface of the desiccant is bared.

4. The organic EL display device according to claim 1, wherein the cushioning member has substantially cylindrical pieces scattered on the surface of the desiccant so that the longitudinal directions of the cylindrical pieces are substantially parallel to the surface of the desiccant.

5. The organic EL display device according to any of claims 1 to 4, wherein the organic EL layer includes an electron transport layer, alight-emitting layer, a hole transport layer, and a hole injection layer.

6. The organic EL display device according to any of claims 1 to 5, wherein the sealing substrate includes a pit in which the desiccant assembly is stored.
